(19) United States
(12) Patent Application Publication
(10) Pub. No.: US 2019/0178803 A1
(43) Pub. Date: Jun. 13, 2019

(54) METHOD OF MEASURING CONCENTRATION OF DISSOLVED ORGANIC NITROGEN IN SEWAGE

(71) Applicant: Nanjing University, Nanjing (CN)

(72) Inventors: Hongqiang REN, Nanjing (CN); Haidong HU, Nanjing (CN); Jinju GENG, Nanjing (CN); Lili DING, Nanjing (CN); Hui HUANG, Nanjing (CN)

(21) Appl. No.: 16/274,213

(22) Filed: Feb. 12, 2019

Related U.S. Application Data
(63) Continuation-in-part of application No. PCT/CN2017/095851, filed on Aug. 3, 2017.

(30) Foreign Application Priority Data
Jan. 20, 2017 (CN) 201710048270.3

(51) Int. Cl. G01N 21/77; G01N 1/34; B01D 61/32; B01D 71/16

(52) U.S. Cl. CPC G01N 21/77; G01N 1/34; B01D 61/32; B01D 61/28; B01D 2325/02; B01D 2325/36; B01D 2325/20; B01D 71/16

(57) ABSTRACT

A method of measuring concentration of dissolved organic nitrogen in sewage. The method includes: filtering a sewage sample using a filter membrane; measuring the concentrations of total dissolved nitrogen (TDN), ammonia nitrogen (NH₄⁺), and nitric nitrogen (NO₃⁻) in the sewage sample, respectively designated as C_{TDN(I)}, C_{NH4}⁺_{(I)} and C_{NO3}⁻_{(I)}; calculating the ratios of (C_{NH4}⁺_{(I)}+C_{NO3}⁻_{(I)})/C_{TDN(I)} and C_{NO3}⁻_{(I)}/C_{NH4}⁺_{(I)}, and according to the ratios, calculating the concentration of dissolved organic nitrogen (DON) in the sewage sample.

### CROSS-REFERENCE TO RELATED APPLICATIONS

This application is a continuation-in-part of International Patent Application No. PCT/CN2017/095851 with an international filing date of Aug. 3, 2017, designating the United States, now pending, and further claims foreign priority benefits to Chinese Patent Application No. 201710048270.3 filed Jan. 20, 2017. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

This disclosure relates to a method of measuring concentration of dissolved organic nitrogen in sewage.

Total dissolved nitrogen (TDN) in sewage includes dissolved inorganic nitrogen (DIN) and dissolved organic nitrogen (DON).

Conventionally, to measure the concentration of DON, the concentrations of TDN and DIN (including ammonia nitrogen, nitrate nitrogen and nitrite nitrogen) are measured, respectively, and then the difference between them is calculated. The entire measurement processes are complex and inefficient, and the results are generally inaccurate.

### SUMMARY

Disclosed is a method of measuring concentration of dissolved organic nitrogen in sewage.

The disclosure provides a method of measuring concentration of dissolved organic nitrogen in sewage, the method comprising:
(1) filtering a sewage sample using a filter membrane;
(2) measuring concentrations of total dissolved nitrogen (TDN), ammonia nitrogen (NH₄⁺), and nitric nitrogen (NO₃⁻) in the sewage sample, respectively designated as C_{TDN(I)}, C_{NH4}⁺_{(I)} and C_{NO3}⁻_{(I)};
(3) calculating ratios of (C_{NH4}⁺_{(I)}+C_{NO3}⁻_{(I)})/C_{TDN(I)} and C_{NO3}⁻_{(I)}/C_{NH4}⁺_{(I)}, and according to the ratios, performing one of the following to measure concentrations of nitrogen-containing groups in the sewage sample;
   (3.1) when (C_{NH4}⁺_{(I)}+C_{NO3}⁻_{(I)})/C_{TDN(I)}<0.7, measuring a concentration of nitrite nitrogen (NO₂⁻) in the sewage sample, designated as C_{NO2}⁻_{(I)}, and calculating a concentration of dissolved organic nitrogen (DON) in the sewage sample as follows: DON=C_{TDN(I)}−C_{NH4}⁺_{(I)}−C_{NO3}⁻_{(I)}−C_{NO2}⁻(I);
   (3.2) when (C_{NH4}⁺_{(I)}+C_{NO3}⁻_{(I)})/C_{TDN(I)}≥0.7 and C_{NO3}⁻_{(I)}/C_{NH4}⁺_{(I)}≥1, dialyzing the sewage sample in a suspended dialysis bag for between 22 and 26 hours, and measuring concentrations of total dissolved nitrogen (TDN), ammonia nitrogen (NH₄⁺), nitric nitrogen (NO₃⁻) and nitrite nitrogen (NO₂⁻) in the sewage sample, respectively designated as C_{TDN(II)}, C_{NH4}⁺_{(II)}, C_{NO3}⁻_{(II)}, and C_{NO2}⁻_{(II)}, and calculating a concentration of dissolved organic nitrogen (DON) in the sewage sample as follows: DON=C_{TDN(II)}−C_{NH4}⁺_{(II)}−C_{NO3}⁻_{(II)}−C_{NO2-(II)}; and
   (3.3) when (C_{NH4}⁺_{(I)}+C_{NO3}⁻_{(I)})/C_{TDN(I)}≥0.7 and C_{NO3}⁻_{(I)}/C_{NH4}⁺_{(I)}<1, dialyzing the sewage sample in a suspended dialysis bag for between 34 and 38 hours, and measuring concentrations of total dissolved nitrogen (TDN), ammonia nitrogen (NH₄⁺), nitric nitrogen (NO₃⁻) and nitrite nitrogen (NO₂⁻) in the sewage sample, respectively designated as C_{TDN(III)}, C_{NH4}⁺_{(III)}, C_{NO3}⁻_{(III)}, and C_{NO2}⁻_{(III)}, and calculating a concentration of dissolved organic nitrogen (DON) in the sewage sample as follows: DON=C_{TDN(III)}−C_{NH4}⁺_{(III)}−C_{NO3}⁻_{(III)}−C_{NO2}⁻_{(III)}.

The filter membrane can have a pore size of 0.45 μm.

The suspended dialysis bag in (3.2) and (3.3) can be a cellulose ester membrane, hydrophilic, and can have a molecular weight cut-off (MWCO) of 100-500 Da; and the hydraulic retention time of the dialysate in the sewage sample can be 4 h.

The concentrations of the total dissolved nitrogen (TDN), ammonia nitrogen (NH₄⁺), nitric nitrogen (NO₃⁻) and nitrite nitrogen (NO₂⁻) can be measured using potassium persulfate oxidation-ion chromatography, salicylic acid-hypochlorite spectrophotometry, ion chromatography and N-(1-naphthyl)-ethylenediamine spectrophotometry, respectively.

Advantages of the method of measuring concentration of dissolved organic nitrogen in sewage in the disclosure are summarized as below.

1. The method is efficient, and energy-saving;

2. The measurement method is accurate; and

3. The method is easy to operate, and is cost-effective.

### BRIEF DESCRIPTION OF THE DRAWINGS

FIG. 1 is a flow chart of a method of measuring concentration of dissolved organic nitrogen in sewage as described in the disclosure; and

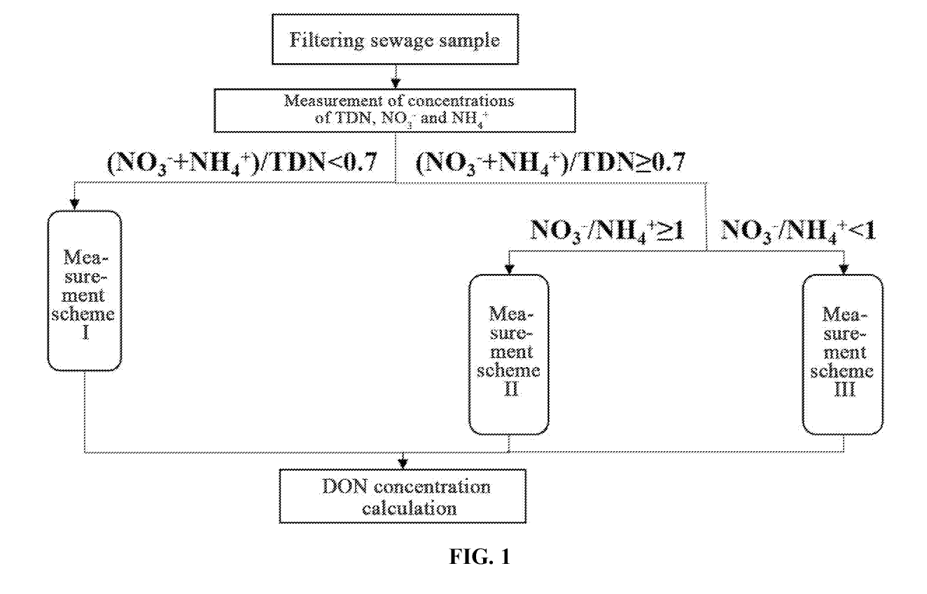

FIG. 2 is a comparison diagram of concentrations of dissolved organic nitrogen measured by conventional methods and the method as described in the disclosure.

### DETAILED DESCRIPTION

To further illustrate, examples detailing a method of measuring concentration of dissolved organic nitrogen in sewage are described below. It should be noted that the following examples are intended to describe and not to limit the description.

### Example 1

1. 100 mL of municipal sewage (labeled as sample 1) was filtered using a filter membrane having a pore size of 0.45 μm.

2. The concentrations of the total dissolved nitrogen (TDN), NH₄⁺ and NO₃⁻ of the sewage were measured using potassium persulfate oxidation-ion chromatography, salicylic acid-hypochlorite spectrophotometry, and ion chromatography, respectively, and were recorded as C_{TDN(I)}, C_{NH4}⁺_{(I)} and C_{NO3}⁻_{(I)};

3. The results showed that (C_{NH4}⁺_{(I)}+C_{NO3}⁻_{(I)})/C_{TDN(I)}=0.92>0.7 and C_{NO3}⁻_{(I)}/C_{NH4}⁺_{(I)}>1. The sewage was dialyzed in a suspended dialysis bag for 24 hours. The suspended dialysis bag was a cellulose ester membrane, hydrophilic, and had a molecular weight cut-off (MWCO) of 100 Da; and the hydraulic retention time of the dialysate in the sewage sample was 4 h. Thereafter, the concentrations of the total dissolved nitrogen (TDN), ammonia nitrogen (NH₄⁺), nitric nitrogen (NO₃⁻) and nitrite nitrogen (NO₂⁻) were measured using potassium persulfate oxidation-ion chromatography, salicylic acid-hypochlorite spectrophotometry, ion chromatography and N-(1-naphthyl)-ethylenediamine spectrophotometry, respectively, and recorded as C_{TDN(II)}, C_{NH4}⁺_{(II)}, C_{NO3}⁻_{(II)}, and C_{NO2}⁻_{(II)}, respectively.

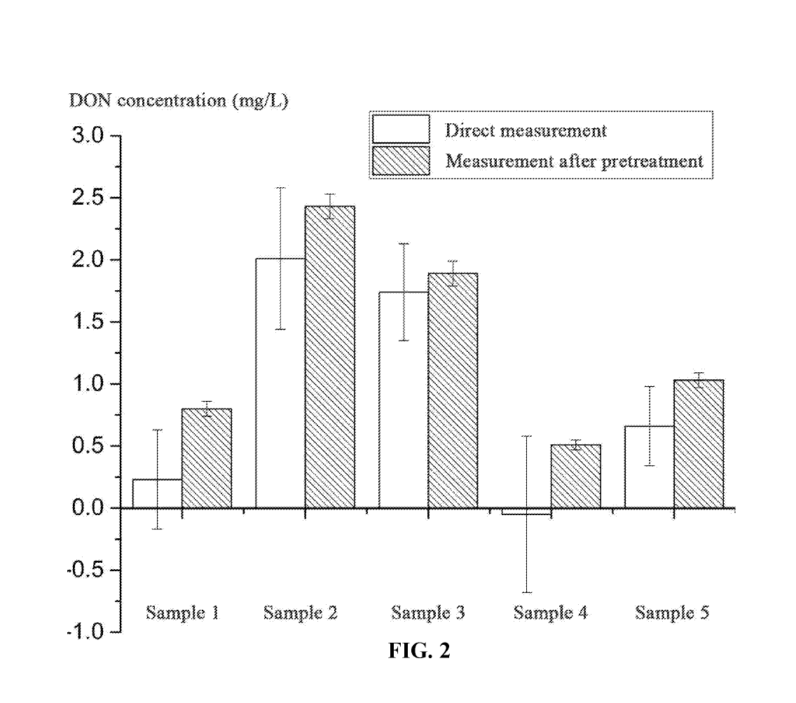

4. The concentration of the dissolved organic nitrogen (DON) in the sewage sample was calculated as follows: DON=C_{TDN(II)}−C_{NH4}⁺_{(II)}−C_{NO3}⁻_{(II)}−C_{NO2-(II)}. The DON in the sample 1 was 0.80 mg/L. To ensure the accuracy and reliability of the measurement, the measurement was performed three times and the measured values were averaged. The results are shown in FIG. 2.

### Example 2

1. 100 mL of municipal anaerobic sewage (labeled as sample 2) was filtered using a filter membrane having a pore size of 0.45 μm.

2. The concentrations of the total dissolved nitrogen (TDN), NH₄⁺ and NO₃⁻ of the sewage were measured using potassium persulfate oxidation-ion chromatography, salicylic acid-hypochlorite spectrophotometry, and ion chromatography, respectively, and were recorded as C_{TDN(I)}, C_{NH4}⁺_{(I)} and C_{NO3}⁻_{(I)};

3. The results showed that (C_{NH4}⁺_{(I)}+C_{NO3}⁻_{(I)})/C_{TDN(I)}=0.73>0.7 and C_{NO3}⁻_{(I)}/C_{NH4}⁺_{(I)}<1. The sewage was dialyzed in a suspended dialysis bag for 34 hours. The suspended dialysis bag was a cellulose ester membrane, hydrophilic, and had a molecular weight cut-off (MWCO) of 100 Da; and the hydraulic retention time of the dialysate in the sewage sample was 4 h. Thereafter, the concentrations of the total dissolved nitrogen (TDN), ammonia nitrogen (NH₄⁺), nitric nitrogen (NO₃⁻) and nitrite nitrogen (NO₂⁻) were measured using potassium persulfate oxidation-ion chromatography, salicylic acid-hypochlorite spectrophotometry, ion chromatography and N-(1-naphthyl)-ethylenediamine spectrophotometry, respectively, and recorded as C_{TDN(III)}, C_{NH4}⁺_{(III)}, C_{NO3}⁻_{(III)}, and C_{NO2}⁻_{(III)}, respectively.

4. The concentration of the dissolved organic nitrogen (DON) in the sewage sample was calculated as follows: DON=C_{TDN(III)}−C_{NH4}⁺_{(III)}−C_{NO3}⁻_{(III)}−C_{NO2}⁻_{(III)}. The DON in the sample 2 was 2.43 mg/L. To ensure the accuracy and reliability of the measurement, the measurement was performed three times and the measured values were averaged. The results are shown in FIG. 2.

### Example 3

1. 100 mL of municipal aerobic sewage (labeled as sample 3) was filtered using a filter membrane having a pore size of 0.45 μm.

2. The concentrations of the total dissolved nitrogen (TDN), NH₄⁺ and NO₃⁻ of the sewage were measured using potassium persulfate oxidation-ion chromatography, salicylic acid-hypochlorite spectrophotometry, and ion chromatography, respectively, and were recorded as C_{TDN(I)}, C_{NH4}⁺_{(I)} and C_{NO3}⁻_{(I)};

3. The results showed that (C_{NH4}⁺_{(I)}+C_{NO3}⁻_{(I)})/C_{TDN(I)}=0.75>0.7 and C_{NO3}⁻_{(I)}/C_{NH4}⁺_{(I)}>1. The sewage was dialyzed in a suspended dialysis bag for 24 hours. The suspended dialysis bag was a cellulose ester membrane, hydrophilic, and had a molecular weight cut-off (MWCO) of 100 Da; and the hydraulic retention time of the dialysate in the sewage sample was 4 h. Thereafter, the concentrations of the total dissolved nitrogen (TDN), ammonia nitrogen (NH₄⁺), nitric nitrogen (NO₃⁻) and nitrite nitrogen (NO₂⁻) were measured using potassium persulfate oxidation-ion chromatography, salicylic acid-hypochlorite spectrophotometry, ion chromatography and N-(1-naphthyl)-ethylenediamine spectrophotometry, respectively, and recorded as C_{TDN(II)}, C_{NH4}⁺_{(II)}, C_{NO3}⁻_{(II)}, and C_{NO2}⁻_{(II)}, respectively.

4. The concentration of the dissolved organic nitrogen (DON) in the sewage sample was calculated as follows: DON=C_{TDN(II)}−C_{NH4}⁺_{(II)}−C_{NO3}⁻_{(II)}−C_{NO2-(II)}. The DON in the sample 3 was 1.89 mg/L. To ensure the accuracy and reliability of the measurement, the measurement was performed three times and the measured values were averaged. The results are shown in FIG. 2.

### Example 4

1. 100 mL of municipal sewage (labeled as sample 4) was filtered using a filter membrane having a pore size of 0.45 μm.

2. The concentrations of the total dissolved nitrogen (TDN), NH₄⁺ and NO₃⁻ of the sewage were measured using potassium persulfate oxidation-ion chromatography, salicylic acid-hypochlorite spectrophotometry, and ion chromatography, respectively, and were recorded as C_{TDN(I)}, C_{NH4}⁺_{(I)} and C_{NO3}⁻_{(I)};

3. The results showed that (C_{NH4}⁺_{(I)}+C_{NO3}⁻_{(I)})/C_{TDN(I)}=0.95>0.7 and C_{NO3}⁻_{(I)}/C_{NH4}⁺_{(I)}>1. The sewage was dialyzed in a suspended dialysis bag for 25 hours. The suspended dialysis bag was a cellulose ester membrane, hydrophilic, and had a molecular weight cut-off (MWCO) of 100 Da; and the hydraulic retention time of the dialysate in the sewage sample was 4 h. Thereafter, the concentrations of the total dissolved nitrogen (TDN), ammonia nitrogen (NH₄⁺), nitric nitrogen (NO₃⁻) and nitrite nitrogen (NO₂⁻) were measured using potassium persulfate oxidation-ion chromatography, salicylic acid-hypochlorite spectrophotometry, ion chromatography and N-(1-naphthyl)-ethylenediamine spectrophotometry, respectively, and recorded as C_{TDN(II)}, C_{NH4}⁺_{(II)}, C_{NO3}⁻_{(II)}, and C_{NO2}⁻_{(II)}, respectively.

4. The concentration of the dissolved organic nitrogen (DON) in the sewage sample was calculated as follows: DON=C_{TDN(II)}−C_{NH4}⁺_{(II)}−C_{NO3}⁻_{(II)}−C_{NO2-(II)}. The DON in the sample 4 was 0.51 mg/L. To ensure the accuracy and reliability of the measurement, the measurement was performed three times and the measured values were averaged. The results are shown in FIG. 2.

### Example 5

1. 100 mL of 0.99 mg/L standard glutamate solution was mixed with 10 mL of 40.09 mg/L potassium nitrate solution. The mixture (labeled as sample 5) was filtered using a filter membrane having a pore size of 0.45 μm.

2. The concentrations of the total dissolved nitrogen (TDN), NH₄⁺ and NO₃⁻ of the mixture were measured using potassium persulfate oxidation-ion chromatography, salicylic acid-hypochlorite spectrophotometry, and ion chromatography, respectively, and were recorded as C_{TDN(I)}, C_{NH4}⁺_{(I)} and C_{NO3}⁻_{(I)};

3. The results showed that (C_{NH4}⁺_{(I)}+C_{NO3}⁻_{(I)})/C_{TDN(I)}=0.81>0.7 and C_{NO3}⁻_{(I)}/C_{NH4}⁺_{(I)}>1. The sewage was dialyzed in a suspended dialysis bag for 24 hours. The suspended dialysis bag was a cellulose ester membrane, hydrophilic, and had a molecular weight cut-off (MWCO) of 100 Da; and the hydraulic retention time of the dialysate in the sewage sample was 4 h. Thereafter, the concentrations of the total dissolved nitrogen (TDN), ammonia nitrogen (NH₄⁺), nitric nitrogen (NO₃⁻) and nitrite nitrogen (NO₂⁻) were measured using potassium persulfate oxidation-ion chromatography, salicylic acid-hypochlorite spectrophotometry, ion chromatography and N-(1-naphthyl)-ethylenediamine spectrophotometry, respectively, and recorded as C_{TDN(II)}, C_{NH4}⁺_{(II)}, C_{NO3}⁻_{(II)}, and C_{NO2}⁻_{(II)}, respectively.

4. The concentration of the dissolved organic nitrogen (DON) in the sewage sample was calculated as follows: DON=C_{TDN(II)}−C_{NH4}⁺_{(II)}−C_{NO3}⁻_{(II)}−C_{NO2-(II)}. The DON in the sample 5 was 1.05 mg/L. To ensure the accuracy and reliability of the measurement, the measurement was performed three times and the measured values were averaged. The results are shown in FIG. 2.

As shown in FIG. 2, when the sewage samples 1-4 were not pretreated using the method described in the disclosure, the standard deviation of the measured values was large, and thus the concentration of the DON in the sewage cannot be concluded, or even a negative value was obtained. According to the measurement method as described in the disclosure, the measured value of the DON concentration of the sample 5 was 1.03±0.03 mg/L, and the standard error between the measured value and the truth value (0.99 mg/L) is 4.04%. The standard error between the DON concentration measured using conventional methods and the truth value in the sample 5 is 33.33%. Therefore, the method of measurement of the concentration of DON is accurate. The standard deviation of the repeated tests is within 10%.

It will be obvious to those skilled in the art that changes and modifications may be made, and therefore, the aim in the appended claims is to cover all such changes and modifications.

What is claimed is:

1. A method, comprising:
(1) filtering a sewage sample using a filter membrane;
(2) measuring concentrations of total dissolved nitrogen (TDN), ammonia nitrogen (NH₄⁺), and nitric nitrogen (NO₃⁻) in the sewage sample, respectively designated as C_{TDN(I)}, C_{NH4}⁺_{(I)} and C_{NO3}⁻_{(I)};
(3) calculating ratios of (C_{NH4}⁺_{(I)}+C_{NO3}⁻_{(I)})/C_{TDN(I)} and C_{NO3}⁻_{(I)}/C_{NH4}⁺_{(I)}, and according to the ratios, performing one of the following to measure concentrations of nitrogen-containing groups in the sewage sample;
(3.1) when (C_{NH4}⁺_{(I)}+C_{NO3}⁻_{(I)})/C_{TDN(I)}<0.7, measuring a concentration of nitrite nitrogen (NO₂⁻) in the sewage sample, designated as C_{NO2}⁻_{(I)}, and calculating a concentration of dissolved organic nitrogen (DON) in the sewage sample as follows: DON=C_{TDN(I)}−C_{NH4}⁺_{(I)}−C_{NO3}⁻_{(I)}−C_{NO2}⁻_{(I)};
(3.2) when (C_{NH4}⁺_{(I)}+C_{NO3}⁻_{(I)})/C_{TDN(I)}≥0.7 and C_{NO3}⁻_{(I)}/C_{NH4}⁺_{(I)}≥1, dialyzing the sewage sample in a suspended dialysis bag for between 22 and 26 hours, and measuring concentrations of total dissolved nitrogen (TDN), ammonia nitrogen (NH₄⁺), nitric nitrogen (NO₃⁻) and nitrite nitrogen (NO₂⁻) in the sewage sample, respectively designated as C_{TDN(II)}, C_{NH4}⁺_{(II)}, C_{NO3}⁻_{(II)}, and C_{NO2}⁻_{(II)}, and calculating a concentration of dissolved organic nitrogen (DON) in the sewage sample as follows: DON=C_{TDN(II)}−C_{NH4}⁺_{(II)}−C_{NO3}⁻_{(II)}−C_{NO2-(II)}; and
(3.3) when (C_{NH4}⁺_{(I)}+C_{NO3}⁻_{(I)})/C_{TDN(I)}≥0.7 and C_{NO3}⁻_{(I)}/C_{NH4}⁺_{(I)}<1, dialyzing the sewage sample in a suspended dialysis bag for between 34 and 38 hours, and measuring concentrations of total dissolved nitrogen (TDN), ammonia nitrogen (NH₄⁺), nitric nitrogen (NO₃⁻) and nitrite nitrogen (NO₂⁻) in the sewage sample, respectively designated as C_{TDN(III)}, C_{NH4}⁺_{(III)}, C_{NO3}⁻_{(III)}, and C_{NO2}⁻_{(III)}, and calculating a concentration of dissolved organic nitrogen (DON) in the sewage sample as follows: DON=C_{TDN(III)}−C_{NH4}⁺_{(III)}−C_{NO3}⁻_{(III)}−C_{NO2}⁻_{(III)}.

2. The method of claim 1, wherein the filter membrane has a pore size of 0.45 μm.

3. The method of claim 1, wherein the suspended dialysis bag in (3.2) and (3.3) is a cellulose ester membrane, hydrophilic, and has a molecular weight cut-off (MWCO) of 100-500 Da; and a hydraulic retention time of a dialysate in the sewage sample is 4 h.

4. The method of claim 1, wherein the concentrations of the total dissolved nitrogen (TDN), ammonia nitrogen (NH₄⁺), nitric nitrogen (NO₃⁻) and nitrite nitrogen (NO₂⁻) are measured using potassium persulfate oxidation-ion chromatography, salicylic acid-hypochlorite spectrophotometry, ion chromatography and N-(1-naphthyl)-ethylenediamine spectrophotometry, respectively.
